(19) United States
(12) Patent Application Publication
(10) Pub. No.: US 2026/0074639 A1
(43) Pub. Date: Mar. 12, 2026

(54) MOTOR CONTROL DEVICE AND MOTOR CONTROL METHOD

(71) Applicant: DENSO CORPORATION, Kariya-city (JP)

(72) Inventor: Tomohide MAKIHARA, Kariya-city (JP)

(73) Assignee: DENSO CORPORATION, Kariya-city (JP)

(21) Appl. No.: 19/395,153

(22) Filed: Nov. 20, 2025

Related U.S. Application Data
(63) Continuation of application No. PCT/JP2024/015719, filed on Apr. 22, 2024.

(30) Foreign Application Priority Data
May 31, 2023 (JP) 2023-090344

(51) Int. Cl. H02P 23/18; H02P 23/14

(52) U.S. Cl. CPC H02P 23/18; H02P 23/14

(57) ABSTRACT

A motor control device includes: a memory configured to store a phase advance angle map in which a phase advance angle map value and a load factor of a motor are associated in advance; a phase advance angle setting unit configured to calculate a load factor of the motor at a motor application voltage that is a voltage to be applied to the motor and set a phase advance angle calculated on the basis of a phase advance angle map value and the motor application voltage; and a PWM drive control unit configured to control the motor at the set phase advance angle. The phase advance angle map value is obtained from the phase advance angle map using the calculated load factor.

### CROSS-REFERENCE TO RELATED APPLICATIONS

The present application is a continuation application of International Application No. PCT/JP2024/015719 filed on Apr. 22, 2024, which claims priority to Japanese Patent Application No. 2023-090344 filed on May 31, 2023. The contents of these applications are incorporated herein by reference in their entirety.

### BACKGROUND

### 1. Technical Field

The present disclosure relates to a motor control device and a motor control method.

### 2. Related Art

The use of vector control allows a brushless motor to be adjusted in the optimum current phase in spite of changes in the rotation speed and the load. It is possible to reduce a current with the optimum motor characteristics and bring the brushless motor into efficient operation.

For example, JP2007049843A describes a vector controller for a permanent magnet synchronous motor. The vector controller controls an output voltage of an electric power converter that drives the permanent magnet synchronous motor on the basis of a second d-axis current command value calculated from a first d-axis current command value, a second q-axis current command value calculated from a first q-axis current command value, a frequency command value, and motor constant settings. This vector controller includes a motor constant identifying arithmetic unit that identifies a motor constant of the permanent magnet synchronous motor connected to the electric power converter using the second d-axis current command value, the second q-axis current command value, the detected value of an output current of the electric power converter, and the motor constant settings. The vector controller controls the driving of the permanent magnet motor using the motor constant identified by the motor constant identifying arithmetic unit for a vector control arithmetic operation.

### SUMMARY

A motor control device according to a first aspect of the present disclosure includes: a storage unit configured to store a phase advance angle map in which a phase advance angle map value and a load factor of a motor are associated in advance; a calculation unit configured to calculate a load factor of the motor at a motor application voltage that is a voltage to be applied to the motor; a setting unit configured to set a phase advance angle calculated on the basis of a phase advance angle map value and the motor application voltage; and a drive control unit configured to control the motor at the set phase advance angle. The phase advance angle map value is obtained from the phase advance angle map using the calculated load factor.

A motor control method according to a second aspect of the present disclosure is a motor control method performed by a motor control device including a storage unit configured to store a phase advance angle map in which a phase advance angle map value and a load factor of a motor are associated in advance. The motor control method includes, by the motor control device: calculating a load factor of the motor at a motor application voltage that is a voltage to be applied to the motor; setting a phase advance angle calculated on the basis of a phase advance angle map value and the motor application voltage; and controlling the motor at the set phase advance angle. The phase advance angle map value is obtained from the phase advance angle map using the calculated load factor.

The technology according to the disclosure has advantageous effects of allowing a d-axis current to be controlled without requiring a current to be detected and without performing complicated arithmetic processing, in spite of changes in the load and the rotation speed of a motor.

### BRIEF DESCRIPTION OF THE DRAWING

The vector control, however, requires a current detection unit that detects a current and an arithmetic unit that performs an arithmetic operation such as coordinate conversion. In particular, in a case where the current has a great change, the periodicity of current control has to be shortened. It is necessary to adopt a microcomputer having high processing performance. In a case where emphasis is put on the cost, the phase advance angle is therefore fixed, or the phase advance angle is set depending on the rotation speed in advance in some cases. In this case, for applications where the rotation speed and the load fluctuate, the d-axis current may excessively grow and the efficiency and the speed controllability may decrease.

An object of the present disclosure is to provide a motor control device and a motor control method that each make it possible to control a d-axis current without requiring a current to be detected and without performing complicated arithmetic processing, in spite of changes in the load and the rotation speed of a motor.

A motor control device according to a first aspect of the present disclosure includes: a storage unit configured to store a phase advance angle map in which a phase advance angle map value and a load factor of a motor are associated in advance; a calculation unit configured to calculate a load factor of the motor at a motor application voltage that is a voltage to be applied to the motor; a setting unit configured to set a phase advance angle calculated on the basis of a phase advance angle map value and the motor application voltage; and a drive control unit configured to control the motor at the set phase advance angle. The phase advance angle map value is obtained from the phase advance angle map using the calculated load factor.

A motor control method according to a second aspect of the present disclosure is a motor control method performed by a motor control device including a storage unit configured to store a phase advance angle map in which a phase advance angle map value and a load factor of a motor are associated in advance. The motor control method includes, by the motor control device: calculating a load factor of the motor at a motor application voltage that is a voltage to be applied to the motor; setting a phase advance angle calculated on the basis of a phase advance angle map value and the motor application voltage; and controlling the motor at the set phase advance angle. The phase advance angle map value is obtained from the phase advance angle map using the calculated load factor.

The object, other objects, features, and advantages of the present disclosure are made clearer by the following detailed description with reference to the accompanying drawings. The drawings are as follows.

FIG. 1 is a block diagram illustrating an example of a configuration of a brushless motor system according to a first embodiment.

FIG. 2 is a diagram schematically illustrating a relationship between a d-axis and a q-axis of a brushless motor according to an embodiment.

FIG. 3 is a graph illustrating an example in which a phase advance angle map according to the embodiment and a phase advance angle map value are set.

FIG. 4A is a graph illustrating an example of a relationship between rotation speed and torque of the brushless motor and a relationship between a d-axis current and the torque when a motor application voltage Va is equal to Vs.

FIG. 4B is a graph illustrating an example of a relationship between the rotation speed and the torque of the brushless motor and a relationship between the d-axis current and the torque when the motor application voltage Va is equal to Vs/2.

FIG. 5 is a block diagram illustrating a configuration of a motor control device according to a comparative example.

FIG. 6 is a flowchart illustrating an example of a flow of phase advance angle control processing by the motor control device according to the first embodiment.

FIG. 7A is a graph illustrating another example in which the phase advance angle map of the brushless motor is set when the motor application voltage Va is equal to Vs.

FIG. 7B is a graph illustrating another example of the relationship between the rotation speed and the torque of the brushless motor when the motor application voltage Va is equal to Vs.

FIG. 8 is a diagram schematically illustrating an example of an upper inversion position and a lower inversion position of a wiper arm provided to a windshield.

FIG. 9 is a graph illustrating a result of a simulation of rotation speed, a phase advance angle, a q-axis current, and a d-axis current of a wiper motor at the upper inversion position and the lower inversion position of the wiper arm.

FIG. 10 is a flowchart illustrating an example of a flow of phase advance angle control processing by a motor control device according to a second embodiment.

FIG. 11A is a diagram illustrating an example of a correction value table in which a load and a phase advance angle correction value are associated.

FIG. 11B is a diagram illustrating an example of a phase advance angle map in which a phase advance angle map value and rotation speed are associated.

FIG. 11C is a diagram illustrating an example of a correspondence relationship between a rotation direction and a load.

FIG. 12 is a flowchart illustrating an example of a flow of phase advance angle control processing by a motor control device according to a third embodiment.

FIG. 13 is a flowchart illustrating an example of a flow of phase advance angle control processing by a motor control device according to a fourth embodiment.

### DETAILED DESCRIPTION OF THE PREFERRED EMBODIMENTS

Hereinafter, examples of modes for carrying out the technology according to the present disclosure will be described in detail with reference to the drawings.

### First Embodiment

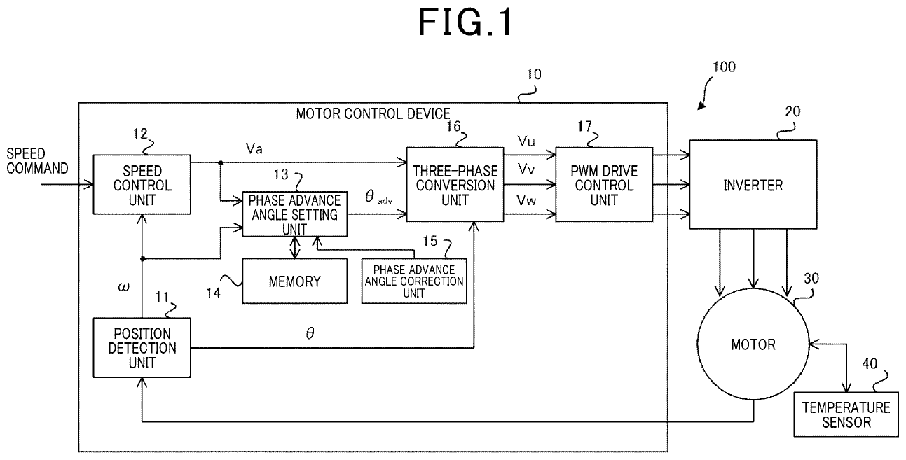

FIG. 1 is a block diagram illustrating an example of the configuration of a brushless motor system 100 according to a first embodiment.

As illustrated in FIG. 1, the brushless motor system 100 according to the present embodiment includes a motor control device 10, an inverter 20, a brushless motor 30, and a temperature sensor 40. As an example, the brushless motor system 100 according to the present embodiment is applied to drive a wiper system that wipes the windshield or the like of a vehicle, but is applicable to various types of auxiliary equipment mounted on a vehicle. It is to be noted that the brushless motor 30 is an example of a motor.

The motor control device 10 is a controller that is connected to the inverter 20 and controls the operation of the brushless motor 30 through the inverter 20. The motor control device 10 includes a microcomputer or the like. The microcomputer includes, for example, a CPU (Central Processing Unit), a ROM (Read Only Memory), a RAM (Random Access Memory), and the like.

The inverter 20 includes a switching element (not illustrated) that is disposed between the motor control device 10 and the brushless motor 30. The switching element connects and disconnects an external power supply (not illustrated) and an armature coil (not illustrated) of the brushless motor 30. This switching element includes, for example, a semiconductor element such as a FET (Field Effect Transistor). More specifically, the switching element includes three switching elements on the positive electrode side that correspond to the U phase, the V phase, and the W phase and are connected to positive electrodes of the external power supply and three switching elements on the negative electrode side that correspond to the U phase, the V phase, and the W phase and are connected to the negative electrode side of the external power supply. When the switching element is connected (turned on) under the control of the motor control device 10, each of the armature coils is supplied with a current from the external power supply. When the switching element is disconnected (turned off) under the control of the motor control device 10, each of the armature coils is supplied with no current from the external power supply. It is to be noted that the external power supply is a battery, a capacitor, or the like mounted on the vehicle.

As an example, a three-phase two-pole or three-phase four-pole motor is used as the brushless motor 30. The brushless motor 30 includes a stator (not illustrated) and a rotor (not illustrated). In addition, the brushless motor 30 includes, for example, a bottomed cylindrical case (not illustrated). The brushless motor 30 is provided with the stator fixed on the inner periphery of the case. The stator includes armature coils for three phases. Specifically, the stator includes armature coils for the U phase, the V phase, and the W phase. The rotor is provided inside the stator. The rotor includes a rotation shaft (not illustrated) and a permanent magnet (not illustrated) attached to the rotation shaft. There is provided a plurality of bearings (not illustrated) in the case. The rotation shaft is supported by the plurality of bearings to be rotatable.

The temperature sensor 40 is a sensor that measures the temperature of the brushless motor 30. A contactless or contact sensor is used. Temperature information resulting from the measurement by the temperature sensor 40 is output to the motor control device 10.

The motor control device 10 according to the present embodiment includes a position detection unit 11, a speed control unit 12, a phase advance angle setting unit 13, a memory 14, a phase advance angle correction unit 15, a three-phase conversion unit 16, and a PWM (Pulse Width Modulation) drive control unit 17.

The position detection unit 11 obtains rotational position signals (e.g., each of electrical angles of 60°) of the brushless motor 30 from three Hall ICs (not illustrated) attached to the brushless motor 30. The position detection unit 11 interpolates and estimates a position between the rotational position signals on the basis of the rotational position signals, thereby calculating an electrical angle θ. The position detection unit 11 outputs the calculated electrical angle θ to the three-phase conversion unit 16. In addition, the position detection unit 11 obtains the current speed (the actual rotation speed also referred to as “actual rotation speed” below) on the basis of conversion using the rotational position signals. The position detection unit 11 outputs converted actual rotation speed ω to both the speed control unit 12 and the phase advance angle setting unit 13.

The speed control unit 12 obtains a speed command including target rotation speed, for example, from a higher-level device such as a PLC (Programmable Logic Controller). Additionally, in a case where the motor control device 10 has a function of generating a program, the motor control device 10 itself may function as a PLC. In addition, the speed control unit 12 obtains the actual rotation speed ω from the position detection unit 11, calculates a motor application voltage Va to decrease the difference between the target rotation speed included in the speed command and the actual rotation speed ω, and outputs the calculated motor application voltage Va to both the phase advance angle setting unit 13 and the three-phase conversion unit 16. The motor application voltage Va is a voltage to be applied to the brushless motor 30.

The memory 14 stores a motor control program and necessary data. The motor control program is for executing phase advance angle control processing according to the present embodiment. In addition, the memory 14 stores a phase advance angle map in advance. In the phase advance angle map, the phase advance angle map value and the load factor of the brushless motor 30 are associated. The memory 14 is an example of a storage unit.

The phase advance angle setting unit 13 calculates the load factor of the brushless motor 30 at the motor application voltage Va that is a voltage to be applied to the brushless motor 30. In addition, the phase advance angle setting unit 13 derives a phase advance angle map value from the phase advance angle map in the memory 14 using the calculated load factor and sets a phase advance angle θ_{adv} calculated on the basis of the derived phase advance angle map value and the motor application voltage Va. The phase advance angle setting unit 13 outputs the set phase advance angle θ_{adv} to the three-phase conversion unit 16. The phase advance angle setting unit 13 is an example of a calculation unit and a setting unit.

The phase advance angle correction unit 15 corrects the phase advance angle θ_{adv} depending on the temperature of the brushless motor 30. The temperature of the brushless motor 30 is obtained by the temperature sensor 40. Specifically, it is conceivable to make a correction using, for example, a data table in which the relationship between the temperature of the brushless motor 30 and the phase advance angle θ_{adv} is associated in advance. The phase advance angle correction unit 15 is an example of a correction unit.

In addition, the phase advance angle correction unit 15 may correct the phase advance angle θ_{adv} on the basis of information obtained from the outside. It is to be noted that the information obtained from the outside is obtained, for example, through a LIN (Local Interconnect Network) as a LIN signal. Specifically, it is conceivable to make a correction using, for example, a data table in which the relationship between the LIN signal and the phase advance angle θ_{adv} is associated in advance.

The three-phase conversion unit 16 obtains the electrical angle θ from the position detection unit 11, obtains the motor application voltage Va from the speed control unit 12, and obtains the phase advance angle θ_{adv} from the phase advance angle setting unit 13. The three-phase conversion unit 16 converts the motor application voltage Va into three-phase motor application voltages Vu, Vv, and Vw on the basis of the electrical angle θ and the phase advance angle θ_{adv}. The three-phase conversion unit 16 outputs the converted three-phase motor application voltages Vu, Vv, and Vw to the PWM drive control unit 17.

The PWM drive control unit 17 obtains the three-phase motor application voltages Vu, Vv, and Vw from the three-phase conversion unit 16, generates PWM signals from the obtained three-phase motor application voltages Vu, Vv, and Vw, and outputs the generated PWM signals to the inverter 20. The PWM drive control unit 17 is an example of the drive control unit.

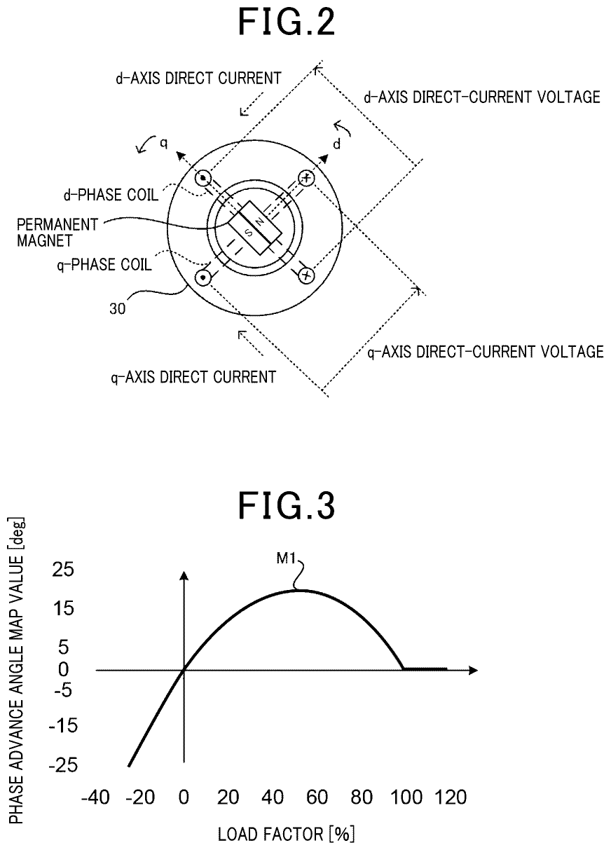

Next, a d-axis and a q-axis of the brushless motor 30 will be specifically described with reference to FIG. 2.

FIG. 2 is a diagram schematically illustrating the relationship between the d-axis and the q-axis of the brushless motor 30 according to the present embodiment.

As illustrated in FIG. 2, a d-phase coil and a q-phase coil are virtually configured in the brushless motor 30. The d-phase coil and the q-phase coil each rotate along with the rotation of the permanent magnet. The d-axis is the direction parallel with a magnetic flux of the magnet and the q-axis is the direction vertical to the d-axis. A d-axis current is a current component that generates a magnetic flux parallel with a magnetic flux of the magnet. The d-axis current is a current component that does not contribute to the torque of the magnet. A q-axis magnetic flux is a current component that generates a magnetic flux vertical to the magnetic flux of the magnet. The d-axis magnetic flux is a current component that generates the torque of the magnet.

A flow of a negative d-axis current cancels the magnetic flux of the magnet and therefore weakens the field. This increases a current within a low-load range, but allows the rotation speed to increase.

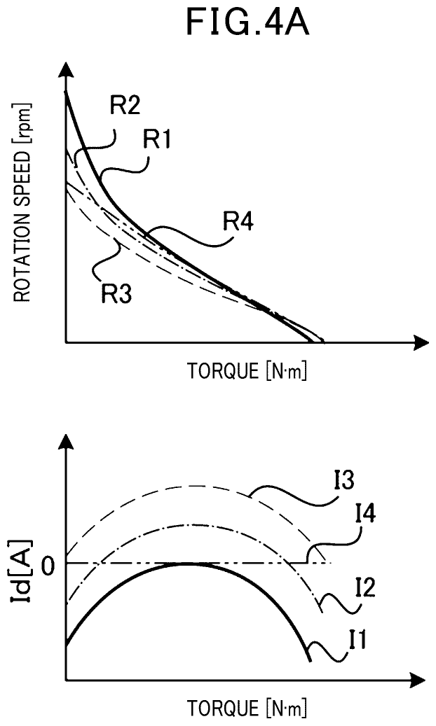

FIG. 3 is a graph illustrating an example in which a phase advance angle map according to the present embodiment and a phase advance angle map value are set. FIG. 3 illustrates a load factor [%] on the horizontal axis and a phase advance angle map value [deg] on the vertical axis. It is to be noted that the numerical values of the graph are examples.

In a phase advance angle map M1 illustrated in FIG. 3, the phase advance angle map value and the load factor of the brushless motor 30 are associated in advance as described above. The phase advance angle map M1 is stored in the memory 14. Here, a load factor L is calculated using, for example, the following Equation (1).

L=Vb/Va (1)

Here, Va represents a motor application voltage and the motor application voltage Va is a voltage determined by the speed control unit 12. Vb represents a motor load voltage and the motor load voltage Vb has a value obtained by subtracting the back electromotive voltage from the motor application voltage Va. The motor load voltage Vb is calculated using, for example, the following Equation (2).

Vb=Va−k×ω (2)

Here, k represents a back electromotive force constant and œ represents actual rotation speed.

In FIG. 3, the phase advance angle map M1 is set such that a d-axis current Id of the brushless motor 30 is zero, for example, in a case where the motor application voltage Va is equal to Vs. Here, the relationship between the phase advance angle θ_{adv} and a phase advance angle map value θₘₚ is expressed by the following Equation (3).

θ_{adv}=θₘₚ×Va/Vs (3)

Here, Va represents a motor application voltage and Vs represents a reference voltage (e.g., 13.5 V).

Here, as an example, a case will be described where the motor application voltage Va is equal to Vs/2. The load factor L of the brushless motor 30 in the case of Va=Vs/2 is calculated using Equation (1) and Equation (2) described above. Next, the phase advance angle map value θₘₚ is derived with reference to the phase advance angle map M1 using the calculated load factor L. The derived phase advance angle map value θₘₚ and the motor application voltage Va=Vs/2 are substituted into Equation (3) described above to calculate the phase advance angle θ_{adv} corresponding to the motor application voltage Va.

Here, the phase advance angle map M1 is set such that the phase advance angle is a phase retard angle, that is, a negative angle, within a range in which the load factor is less than a predetermined value. Specifically, it is desirable that the range in which the load factor is less than the predetermined value be a range in which the load factor is negative. The “phase advance angle” according to the present embodiment includes a positive phase advance angle and even a phase retard angle that is a negative phase advance angle.

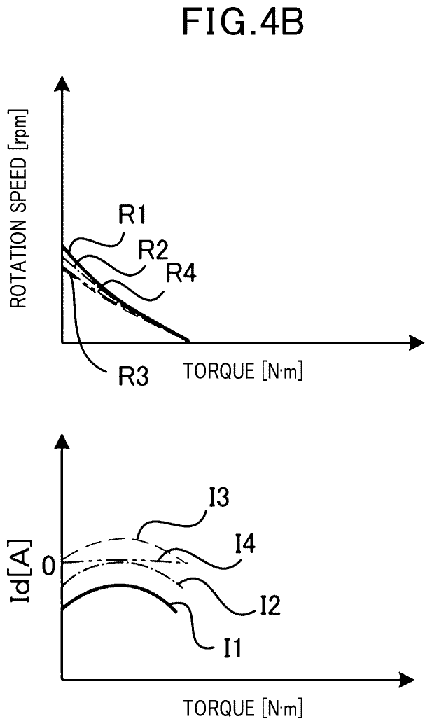

FIG. 4A is a graph illustrating an example of the relationship between the rotation speed and the torque of the brushless motor 30 and the relationship between the d-axis current Id and the torque when the motor application voltage Va is equal to Vs. FIG. 4B is a graph illustrating an example of the relationship between the rotation speed and the torque of the brushless motor 30 and the relationship between the d-axis current Id and the torque when the motor application voltage Va is equal to Vs/2.

In each of FIGS. 4A and 4B, the horizontal axis of the upper graph represents torque [N·m] and the vertical axis represents rotation speed [rpm]. A characteristic R1 illustrated in the upper graph indicates a phase advance angle of 20°. A characteristic R2 indicates a phase advance angle of 10°. A characteristic R3 indicates a phase advance angle of 0°. A characteristic R4 indicates a case where Id is equal to zero in the present embodiment. In addition, the horizontal axis of the lower graph represents torque [N·m] and the vertical axis represents the d-axis current Id [A]. A characteristic I1 illustrated in the lower graph indicates a phase advance angle of 20°. A characteristic I2 indicates a phase advance angle of 10°. A characteristic I3 indicates a phase advance angle of 0°. A characteristic I4 indicates a case where Id is equal to zero in the present embodiment.

As illustrated in FIGS. 4A and 4B, the phase advance angle is adjusted depending on the motor application voltage, thereby causing the d-axis current Id to be substantially zero in spite of changes in the motor application voltage, the rotation speed, and the torque. That is, it is possible to perform control similar to Id=0 control that is a type of vector control.

It is to be noted that sine-wave energization or substantial sine-wave energization achieved using a waveform obtained by superimposing a third harmonic on a sine wave has been described above, but the application to, for example, various energization methods such as square-wave energization and trapezoidal-wave energization is also possible. In this case, it is not possible to satisfy Id=0 as with the sine-wave energization, but it is possible to set the phase advance angle that minimizes Id.

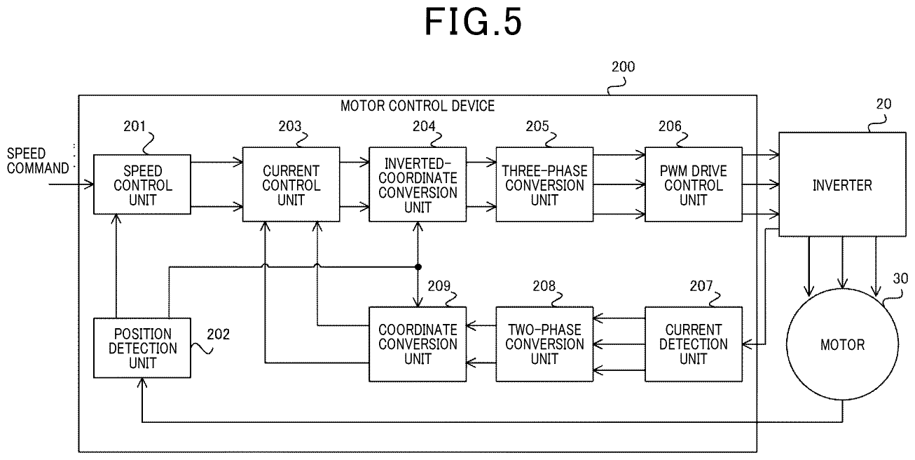

FIG. 5 is a block diagram illustrating the configuration of a motor control device 200 according to a comparative example.

As illustrated in FIG. 5, the motor control device 200 according to the comparative example includes a speed control unit 201, a position detection unit 202, a current control unit 203, an inverted-coordinate conversion unit 204, a three-phase conversion unit 205, a PWM drive control unit 206, a current detection unit 207, a two-phase conversion unit 208, and a coordinate conversion unit 209.

The motor control device 200 according to the comparative example is configured to perform vector control. The motor control device 200 that performs vector control requires the current detection unit 207 that detects a current, and the inverted-coordinate conversion unit 204 and the coordinate conversion unit 209 that are arithmetic units which each perform an arithmetic operation of converting coordinates as described above. In particular, in a case where the current has a great change, the periodicity of current control has to be shortened. It is necessary to adopt a microcomputer having high processing performance. In a case where emphasis is put on the cost, the phase advance angle is therefore fixed or the phase advance angle is set depending on the rotation speed in advance in some cases. In this case, for applications where the rotation speed and the load fluctuate, the d-axis current may grow excessively and the efficiency and the speed controllability may decrease.

In contrast, the motor control device 10 according to the present embodiment stores and has the phase advance angle map M1 in which the phase advance angle map value and the load factor of the brushless motor 30 are associated. The motor control device 10 calculates the load factor L of the brushless motor 30 at the motor application voltage Va, sets the phase advance angle θ_{adv} calculated on the basis of the phase advance angle map value θₘₚ obtained from the phase advance angle map M1 using the calculated load factor L and the motor application voltage Va, and controls the brushless motor 30 at the set phase advance angle θ_{adv}.

This allows the d-axis current to be controlled without requiring a current to be detected and performing complicated arithmetic processing in spite of changes in the load and the rotation speed of the brushless motor 30.

Additionally, in a case where the rotation speed of the brushless motor 30 is less than or equal to a threshold, the phase advance angle setting unit 13 may switch on a mode in which the phase advance angle θ_{adv} is fixed. It is to be noted that an appropriate value is set as the threshold, for example, on the basis of the existing knowledge or an experiment result. For example, in a case where an electrical angle is detected using a Hall IC, an estimation error in the electrical angle grows larger at the time of the start, at which the rotation speed is low. The fixation at the phase advance angle θ_{adv} that allows torque to be reliably generated is therefore desirable.

In addition, the phase advance angle correction unit 15 may correct the phase advance angle θ_{adv} depending on the temperature of the brushless motor 30. This makes it possible to reduce the influence of the characteristics changed because of environmental temperature and heat generated by the motor.

In addition, the phase advance angle correction unit 15 may correct the phase advance angle θ_{adv} on the basis of information (e.g., LIN signal) obtained from the outside. This makes it possible to correct the phase advance angle θ_{adv} depending on changes in the environmental temperature and the external environment.

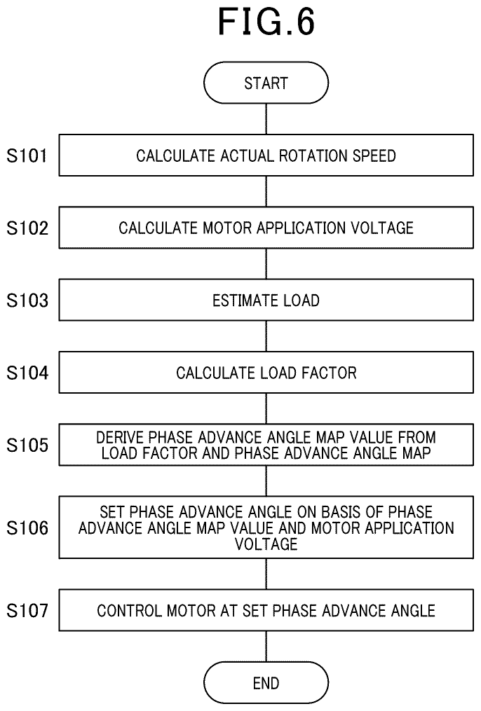

Next, the effects of the motor control device 10 according to the first embodiment will be described with reference to FIG. 6.

FIG. 6 is a flowchart illustrating an example of the flow of the phase advance angle control processing by the motor control device 10 according to the first embodiment.

First, when the motor control device 10 is instructed to execute phase advance angle control processing, a motor control program is started to execute each of the following steps.

In step S101 of FIG. 6, the position detection unit 11 obtains rotational position signals (e.g., each of electrical angles of 60°) of the brushless motor 30 from three Hall ICs (not illustrated) attached to the brushless motor 30. The position detection unit 11 interpolates and estimates a position between the rotational position signals on the basis of the rotational position signals, thereby calculating the electrical angle θ. The position detection unit 11 outputs the calculated electrical angle θ to the three-phase conversion unit 16. In addition, the position detection unit 11 obtains the actual rotation speed ω on the basis of conversion using the rotational position signals. The position detection unit 11 outputs the converted actual rotation speed ω to both the speed control unit 12 and the phase advance angle setting unit 13.

In step S102, the speed control unit 12 obtains, for example, a speed command including target rotation speed from a higher-level device such as a PLC and obtains the actual rotation speed ω from the position detection unit 11. The speed control unit 12 calculates the motor application voltage Va to decrease the difference between the target rotation speed included in the speed command and the actual rotation speed ω and outputs the calculated motor application voltage Va to both the phase advance angle setting unit 13 and the three-phase conversion unit 16.

In step S103, the phase advance angle setting unit 13 estimates the load of the brushless motor 30. For example, (motor application voltage Va-back electromotive voltage) is estimated as a parameter corresponding to the load. Specifically, as an example, the motor load voltage Vb is calculated using Equation (2) described above.

In step S104, the phase advance angle setting unit 13 calculates the load factor L from the motor application voltage Va calculated in step S102 and the motor load voltage Vb calculated in step S103 using Equation (1) described above as an example.

In step S105, the phase advance angle setting unit 13 derives the phase advance angle map value θₘₚ with reference to the phase advance angle map M1 stored in the memory 14 using the load factor L calculated in step S104.

In step S106, the phase advance angle setting unit 13 substitutes the phase advance angle map value θₘₚ derived in step S105 and the motor application voltage Va calculated in step S102 into Equation (3) described above to calculate the phase advance angle θ_{adv} corresponding to the motor application voltage Va. The phase advance angle setting unit 13 outputs the set phase advance angle θ_{adv} to the three-phase conversion unit 16.

In step S107, the three-phase conversion unit 16 obtains the electrical angle θ from the position detection unit 11, obtains the motor application voltage Va from the speed control unit 12, and obtains the phase advance angle θ_{adv} from the phase advance angle setting unit 13. The three-phase conversion unit 16 converts the motor application voltage Va into the three-phase motor application voltages Vu, Vv, and Vw on the basis of the electrical angle θ and the phase advance angle θ_{adv}. The three-phase conversion unit 16 outputs the converted three-phase motor application voltages Vu, Vv, and Vw to the PWM drive control unit 17. The PWM drive control unit 17 controls the driving of the brushless motor 30 on the basis of the motor application voltages Vu, Vv, and Vw and brings the phase advance angle control processing by this motor control program to an end.

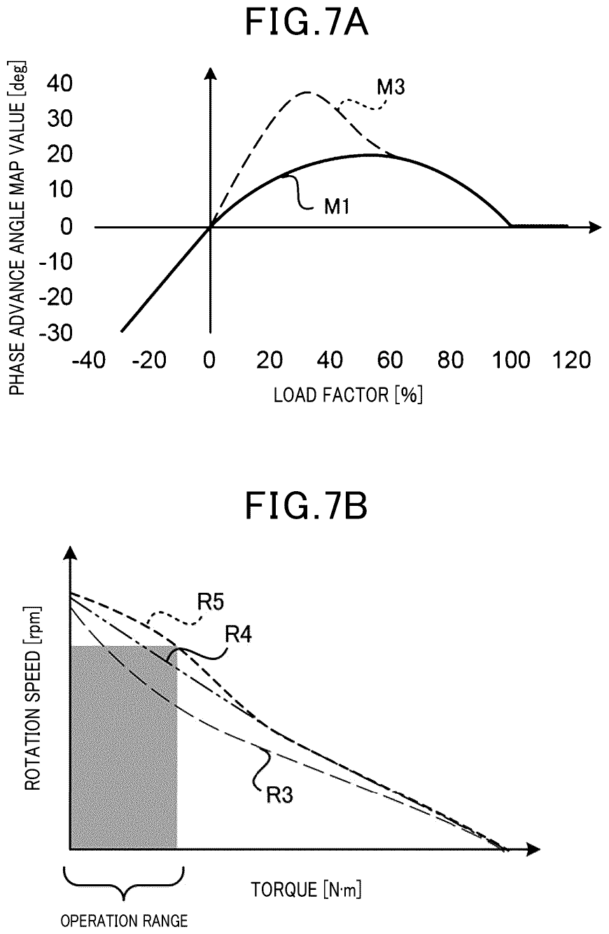

FIG. 7A is a graph illustrating another example in which the phase advance angle map of the brushless motor 30 is set when the motor application voltage Va is equal to Vs. In addition, FIG. 7B is a graph illustrating another example of the relationship between the rotation speed and the torque of the brushless motor 30 when the motor application voltage Va is equal to Vs.

A phase advance angle map M3 illustrated in FIG. 7A is set such that the phase advance angle of the brushless motor 30 is larger within a specific load factor range.

Here, the phase advance angle map M3 illustrated in FIG. 7A is set such that the phase advance angle map value θₘₚ is larger within only the specific load factor range in comparison with the phase advance angle map M1 set such that the d-axis current Id is zero. Field weakening is brought about by the negative d-axis current Id to increase the rotation speed of the motor.

That is, as indicated by a characteristic R5 illustrated in FIG. 7B, a weak field region is set depending on the operation range of a product, thereby making it possible to increase the rotation speed of the motor within the operation range of the product and compensate for the characteristics within the operation range.

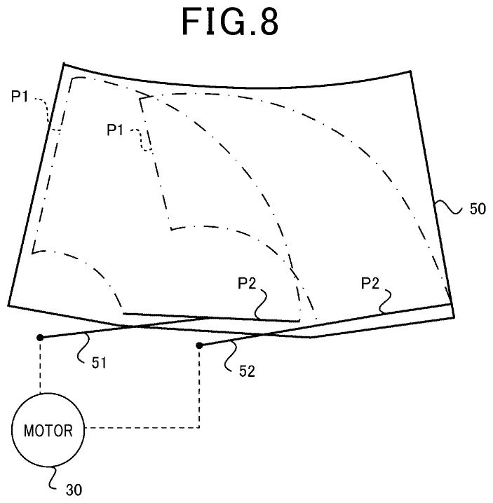

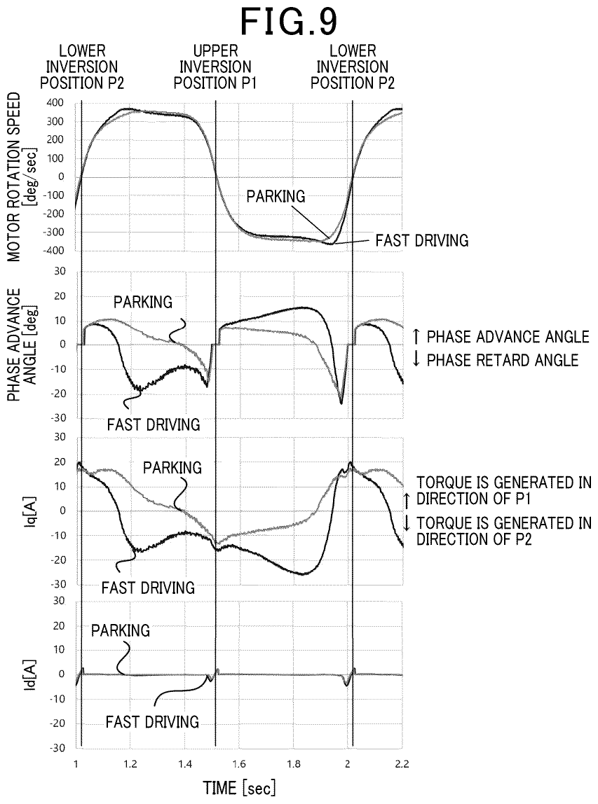

Next, a result of a simulation in which the phase advance angle control processing by the motor control device 10 according to the present embodiment is applied to a wiper system will be described with reference to FIGS. 8 and 9.

FIG. 8 is a diagram schematically illustrating an example of an upper inversion position P1 and a lower inversion position P2 of wiper arms 51 and 52 provided to a windshield 50. In addition, FIG. 9 is a graph illustrating a result of a simulation of the rotation speed, the phase advance angle, a q-axis current Iq, and the d-axis current Id of a wiper motor at the upper inversion position P1 and the lower inversion position P2 of the wiper arms 51 and 52.

A load change made by wind resistance is reproduced by a simulation using the phase advance angle map M1 illustrated in FIG. 3 described above and the effects of the phase advance angle control processing according to the present embodiment are confirmed.

A case will be assumed where the brushless motor 30 according to the present embodiment is driven in direct or indirect connection and used to drive the wiper arms 51 and 52 of the wiper system as illustrated in FIG. 8. The wiper arms 51 and 52 are provided to the windshield 50 and reciprocate between the upper inversion position P1 and the lower inversion position P2.

To reliably generate torque, the phase advance angle is fixed at 0° when the rotation speed of the motor is low. The q-axis current Iq has a value proportional to the torque generated by the motor. The load therefore differs much between parking and fast driving as illustrated in FIG. 9. Meanwhile, the phase advance angle appropriately changes depending on the load condition. It is shown that the d-axis current Id can be kept substantially zero regardless of the load condition.

A forward stroke, that is, a stroke from the lower inversion position P2 to the upper inversion position P1, makes the phase advance angle a phase retard angle (i.e., a negative phase advance angle) because the influence of wind brings about a regenerative operation. In contrast, a return stroke, that is, a stroke from the upper inversion position P1 to the lower inversion position P2, increases the phase advance angle because the influence of wind increases the load.

In this way, the present embodiment allows the d-axis current to be controlled without requiring a current to be detected and performing complicated arithmetic processing in spite of changes in the load and the rotation speed of the motor.

### Second Embodiment

In the first embodiment, the mode in which the phase advance angle control processing is performed using the phase advance angle map in which the phase advance angle map value and the load factor are associated has been described. In a second embodiment, a mode in which the phase advance angle control processing is performed using a phase advance angle map in which the phase advance angle map value and the rotation speed are associated will be described.

The functional configuration of a motor control device 10A according to the second embodiment is similar to that of the motor control device 10 (see FIG. 1) according to the first embodiment. The memory 14 of the motor control device 10A according to the second embodiment stores a phase advance angle map in which the phase advance angle map value and the rotation speed of the brushless motor 30 are associated in advance. The memory 14 is an example of the storage unit.

The phase advance angle setting unit 13 is an example of an estimation unit and estimates the load of the brushless motor 30. The phase advance angle setting unit 13 is an example of the calculation unit and calculates a phase advance angle correction value from the estimated load. The phase advance angle setting unit 13 is an example of a setting unit and sets a phase advance angle calculated on the basis of the phase advance angle map value obtained from the phase advance angle map in the memory 14 using the actual rotation speed of the brushless motor 30 and the calculated phase advance angle correction value.

The PWM drive control unit 17 is an example of a drive control unit and controls the brushless motor 30 at the phase advance angle set by the phase advance angle setting unit 13.

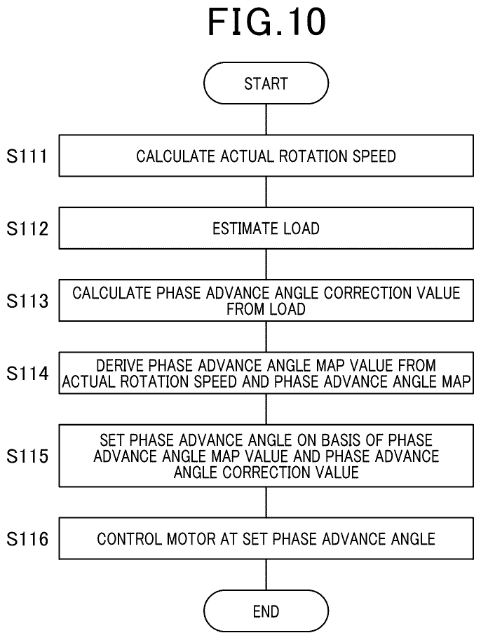

Next, the effects of the motor control device 10A according to the second embodiment will be described with reference to FIG. 10.

FIG. 10 is a flowchart illustrating an example of the flow of phase advance angle control processing by the motor control device 10A according to the second embodiment.

First, when the motor control device 10A is instructed to execute phase advance angle control processing, a motor control program is started to execute each of the following steps.

In step S111 of FIG. 10, the position detection unit 11 obtains rotational position signals (e.g., each of electrical angles of 60°) of the brushless motor 30 from three Hall ICs (not illustrated) attached to the brushless motor 30. The position detection unit 11 interpolates and estimates a position between the rotational position signals on the basis of the rotational position signals, thereby calculating an electrical angle. The position detection unit 11 outputs the calculated electrical angle to the three-phase conversion unit 16. In addition, the position detection unit 11 obtains the actual rotation speed on the basis of conversion using the rotational position signals. The position detection unit 11 outputs the converted actual rotation speed to both the speed control unit 12 and the phase advance angle setting unit 13.

The speed control unit 12 then obtains, for example, a speed command including target rotation speed from a higher-level device such as a PLC and obtains the actual rotation speed from the position detection unit 11. The speed control unit 12 calculates a motor application voltage to decrease the difference between the target rotation speed included in the speed command and the actual rotation speed and outputs the calculated motor application voltage to both the phase advance angle setting unit 13 and the three-phase conversion unit 16.

In step S112, the phase advance angle setting unit 13 estimates the load of the brushless motor 30. For example, (motor application voltage-back electromotive voltage) is estimated as a parameter corresponding to the load. Specifically, as an example, the motor load voltage is calculated using Equation (2) described above.

In step S113, the phase advance angle setting unit 13 calculates a phase advance angle correction value from the load (e.g., motor load voltage) estimated in step S112.

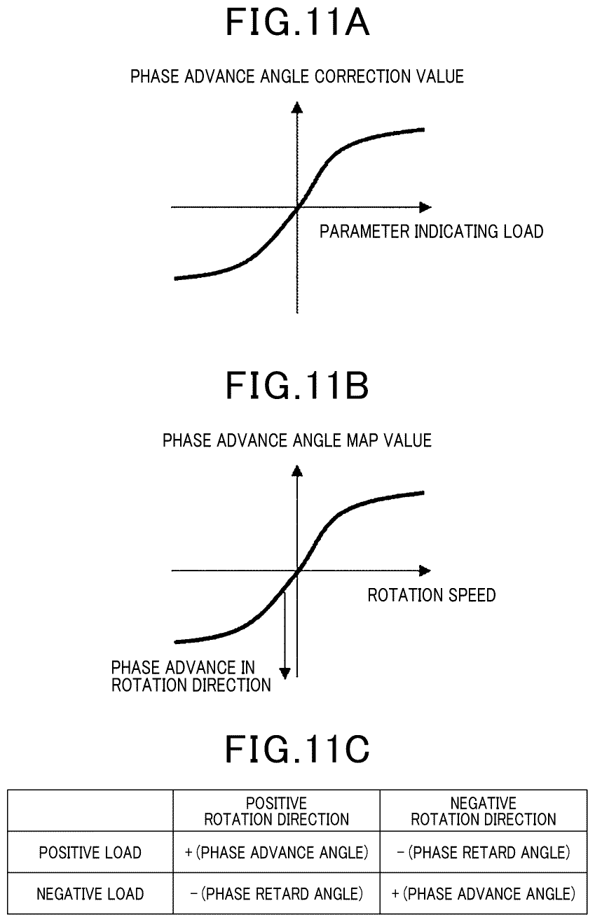

FIG. 11A is a diagram illustrating an example of a correction value table in which the load and the phase advance angle correction value are associated. This correction value table is stored in the memory 14 in advance. As an example, the phase advance angle setting unit 13 calculates a phase advance angle correction value with reference to the correction value table illustrated in FIG. 11A using the estimated load (e.g., motor load voltage).

In step S114, the phase advance angle setting unit 13 derives a phase advance angle map value with reference to the phase advance angle map stored in the memory 14 using the actual rotation speed calculated in step S111.

FIG. 11B is a diagram illustrating an example of the phase advance angle map in which the phase advance angle map value and the rotation speed are associated. This phase advance angle map is stored in the memory 14 in advance. As an example, the phase advance angle setting unit 13 calculates a phase advance angle map value with reference to the phase advance angle map illustrated in FIG. 11B using the actual rotation speed.

In step S115, the phase advance angle setting unit 13 sets a phase advance angle calculated on the basis of the phase advance angle map value derived in step S114 and the phase advance angle correction value calculated in step S113. The phase advance angle setting unit 13 outputs the set phase advance angle to the three-phase conversion unit 16.

FIG. 11C is a diagram illustrating an example of the corresponding relationship between the rotation direction and the load. As an example, the phase advance angle setting unit 13 calculates a phase advance angle by multiplying the phase advance angle map value by the phase advance angle correction value. The sign (+/−) of the phase advance angle is determined on the basis of the corresponding relationship illustrated in FIG. 11C.

In step S116, the three-phase conversion unit 16 obtains an electrical angle from the position detection unit 11, obtains a motor application voltage from the speed control unit 12, and obtains a phase advance angle from the phase advance angle setting unit 13. The three-phase conversion unit 16 converts the motor application voltage into three-phase (the u phase, the v phase, and the w phase) motor application voltages on the basis of the electrical angle and the phase advance angle. The three-phase conversion unit 16 outputs the converted three-phase motor application voltages to the PWM drive control unit 17. The PWM drive control unit 17 controls the driving of the brushless motor 30 on the basis of the three-phase motor application voltages and brings the phase advance angle control processing by this motor control program to an end.

In this way, the present embodiment allows the d-axis current to be controlled without requiring a current to be detected and performing complicated arithmetic processing in spite of changes in the load and the rotation speed of the motor as in the first embodiment described above.

### Third Embodiment

In a third embodiment, a mode in which the phase advance angle control processing is performed using a phase advance angle map in which the phase advance angle map value and the load are associated will be described.

The functional configuration of a motor control device 10B according to the third embodiment is similar to that of the motor control device 10 (see FIG. 1) according to the first embodiment. The memory 14 of the motor control device 10B according to the third embodiment stores a phase advance angle map in which the phase advance angle map value and the load of the brushless motor 30 are associated in advance. The memory 14 is an example of the storage unit.

The phase advance angle setting unit 13 is an example of the estimation unit and estimates the load of the brushless motor 30. The phase advance angle setting unit 13 is an example of the calculation unit and calculates a phase advance angle correction value from the actual rotation speed. The phase advance angle setting unit 13 is an example of the setting unit and sets a phase advance angle calculated on the basis of the phase advance angle map value obtained from the phase advance angle map in the memory 14 using the load of the brushless motor 30 and the calculated phase advance angle correction value.

The PWM drive control unit 17 is an example of the drive control unit and controls the brushless motor 30 at the phase advance angle set by the phase advance angle setting unit 13.

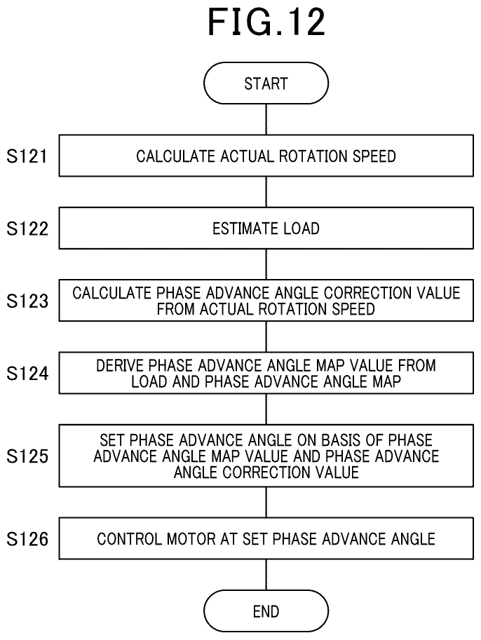

Next, the effects of the motor control device 10B according to the third embodiment will be described with reference to FIG. 12.

FIG. 12 is a flowchart illustrating an example of the flow of phase advance angle control processing by the motor control device 10B according to the third embodiment.

First, when the motor control device 10B is instructed to execute phase advance angle control processing, a motor control program is started to execute each of the following steps.

In step S121 of FIG. 12, the position detection unit 11 obtains rotational position signals (e.g., each of electrical angles of 60°) of the brushless motor 30 from three Hall ICs (not illustrated) attached to the brushless motor 30. The position detection unit 11 interpolates and estimates a position between the rotational position signals on the basis of the rotational position signals, thereby calculating an electrical angle. The position detection unit 11 outputs the calculated electrical angle to the three-phase conversion unit 16. In addition, the position detection unit 11 obtains the actual rotation speed on the basis of conversion using the rotational position signals. The position detection unit 11 outputs the converted actual rotation speed to both the speed control unit 12 and the phase advance angle setting unit 13.

The speed control unit 12 then obtains, for example, a speed command including target rotation speed from a higher-level device such as a PLC and obtains the actual rotation speed from the position detection unit 11. The speed control unit 12 calculates a motor application voltage to decrease the difference between the target rotation speed included in the speed command and the actual rotation speed and outputs the calculated motor application voltage to both the phase advance angle setting unit 13 and the three-phase conversion unit 16.

In step S122, the phase advance angle setting unit 13 estimates the load of the brushless motor 30. For example, (motor application voltage-back electromotive voltage) is estimated as a parameter corresponding to the load. Specifically, as an example, the motor load voltage is calculated using Equation (2) described above.

In step S123, the phase advance angle setting unit 13 calculates a phase advance angle correction value from the actual rotation speed calculated in step S121. In this case, the correction value table illustrated in FIG. 11A described above may be used as a correction value table in which the rotation speed and the phase advance angle correction value are associated. This correction value table is stored in the memory 14 in advance. As an example, the phase advance angle setting unit 13 calculates a phase advance angle correction value with reference to the correction value table using the calculated actual rotation speed.

In step S124, the phase advance angle setting unit 13 derives a phase advance angle map value with reference to the phase advance angle map stored in the memory 14 using the load estimated in step S122. In this case, the phase advance angle map illustrated in FIG. 11B described above may be used as a phase advance angle map in which the load and the phase advance angle map value are associated. This phase advance angle map is stored in the memory 14 in advance. As an example, the phase advance angle setting unit 13 calculates a phase advance angle map value with reference to the phase advance angle map using the estimated load.

In step S125, the phase advance angle setting unit 13 sets a phase advance angle calculated on the basis of the phase advance angle map value derived in step S124 and the phase advance angle correction value calculated in step S123. As an example, the phase advance angle setting unit 13 calculates a phase advance angle by multiplying the phase advance angle map value by the phase advance angle correction value. The phase advance angle setting unit 13 outputs the set phase advance angle to the three-phase conversion unit 16.

In step S126, the three-phase conversion unit 16 obtains an electrical angle from the position detection unit 11, obtains a motor application voltage from the speed control unit 12, and obtains a phase advance angle from the phase advance angle setting unit 13. The three-phase conversion unit 16 converts the motor application voltage into three-phase (the u phase, the v phase, and the w phase) motor application voltages on the basis of the electrical angle and the phase advance angle. The three-phase conversion unit 16 outputs the converted three-phase motor application voltages to the PWM drive control unit 17. The PWM drive control unit 17 controls the driving of the brushless motor 30 on the basis of the three-phase motor application voltages and brings the phase advance angle control processing by this motor control program to an end.

In this way, the present embodiment allows the d-axis current to be controlled without requiring a current to be detected and performing complicated arithmetic processing in spite of changes in the load and the rotation speed of the motor as in the first embodiment described above.

### Fourth Embodiment

In a fourth embodiment, a mode will be described in which phase advance angle control processing is performed using a first phase advance angle map in which the phase advance angle map value and the rotation speed are associated and a second phase advance angle map in which the phase advance angle map value and the load are associated.

The functional configuration of a motor control device 10C according to the fourth embodiment is similar to that of the motor control device 10 (see FIG. 1) according to the first embodiment. The memory 14 of the motor control device 10C according to the fourth embodiment stores, in advance, a first phase advance angle map in which the phase advance angle map value and the rotation speed of the brushless motor 30 are associated and a second phase advance angle map in which the phase advance angle map value and the load are associated. The memory 14 is an example of a first storage unit and a second storage unit.

The phase advance angle setting unit 13 is an example of the estimation unit and estimates the load of the brushless motor 30. The phase advance angle setting unit 13 is an example of the setting unit and sets a phase advance angle calculated using a first phase advance angle map value obtained from the first phase advance angle map in the memory 14 using the actual rotation speed of the brushless motor 30 and a second phase advance angle map value obtained from the second phase advance angle map in the memory 14 using the estimated load.

The PWM drive control unit 17 is an example of the drive control unit and controls the brushless motor 30 at the phase advance angle set by the phase advance angle setting unit 13.

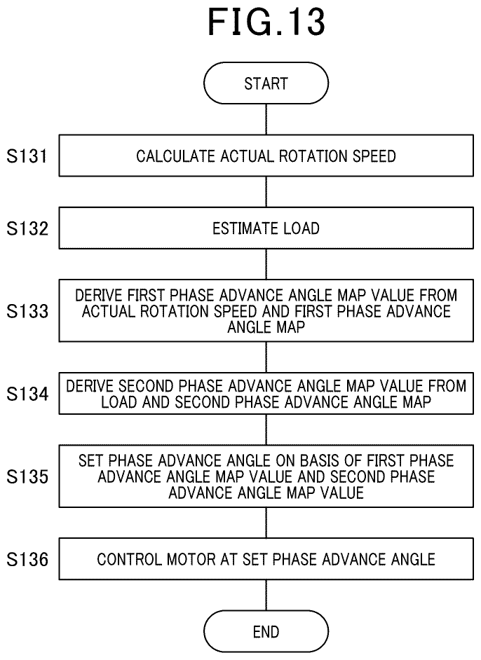

Next, the effects of the motor control device 10C according to the fourth embodiment will be described with reference to FIG. 13.

FIG. 13 is a flowchart illustrating an example of the flow of phase advance angle control processing by the motor control device 10C according to the fourth embodiment.

First, when the motor control device 10C is instructed to execute phase advance angle control processing, a motor control program is started to execute each of the following steps.

In step S131 of FIG. 13, the position detection unit 11 obtains rotational position signals (e.g., each of electrical angles of 60°) of the brushless motor 30 from three Hall ICs (not illustrated) attached to the brushless motor 30. The position detection unit 11 interpolates and estimates a position between the rotational position signals on the basis of the rotational position signals, thereby calculating an electrical angle. The position detection unit 11 outputs the calculated electrical angle to the three-phase conversion unit 16. In addition, the position detection unit 11 obtains the actual rotation speed on the basis of conversion using the rotational position signals. The position detection unit 11 outputs the converted actual rotation speed to both the speed control unit 12 and the phase advance angle setting unit 13.

The speed control unit 12 then obtains, for example, a speed command including target rotation speed from a higher-level device such as a PLC and obtains the actual rotation speed from the position detection unit 11. The speed control unit 12 calculates a motor application voltage to decrease the difference between the target rotation speed included in the speed command and the actual rotation speed and outputs the calculated motor application voltage to both the phase advance angle setting unit 13 and the three-phase conversion unit 16.

In step S132, the phase advance angle setting unit 13 estimates the load of the brushless motor 30. For example, (motor application voltage-back electromotive voltage) is estimated as a parameter corresponding to the load. Specifically, as an example, the motor load voltage is calculated using Equation (2) described above.

In step S133, the phase advance angle setting unit 13 derives a first phase advance angle map value with reference to the first phase advance angle map stored in the memory 14 using the actual rotation speed calculated in step S131. In this case, as an example, the phase advance angle setting unit 13 calculates a first phase advance angle map value with reference to the first phase advance angle map illustrated in FIG. 11B described above using the actual rotation speed.

In step S134, the phase advance angle setting unit 13 derives a second phase advance angle map value with reference to the second phase advance angle map stored in the memory 14 using the load estimated in step S132. In this case, the first phase advance angle map illustrated in FIG. 11B described above may be used as the second phase advance angle map in which the load and the phase advance angle map value are associated. As an example, the phase advance angle setting unit 13 calculates a second phase advance angle map value with reference to the second phase advance angle map using the estimated load.

In step S135, the phase advance angle setting unit 13 sets a phase advance angle calculated using the first phase advance angle map value derived in step S133 and the second phase advance angle map value derived in step S134. As an example, the phase advance angle setting unit 13 calculates a phase advance angle by multiplying the first phase advance angle map value by the second phase advance angle map value. The phase advance angle setting unit 13 outputs the set phase advance angle to the three-phase conversion unit 16.

In step S136, the three-phase conversion unit 16 obtains an electrical angle from the position detection unit 11, obtains a motor application voltage from the speed control unit 12, and obtains a phase advance angle from the phase advance angle setting unit 13. The three-phase conversion unit 16 converts the motor application voltage into three-phase (the u phase, the v phase, and the w phase) motor application voltages on the basis of the electrical angle and the phase advance angle. The three-phase conversion unit 16 outputs the converted three-phase motor application voltages to the PWM drive control unit 17. The PWM drive control unit 17 controls the driving of the brushless motor 30 on the basis of the three-phase motor application voltages and brings the phase advance angle control processing by this motor control program to an end.

In this way, the present embodiment allows the d-axis current to be controlled without requiring a current to be detected and performing complicated arithmetic processing in spite of changes in the load and the rotation speed of the motor as in the first embodiment described above.

As to the embodiments described above, the following supplementary notes will be further disclosed.

### Supplementary Note 1

A motor control device including:
a storage unit configured to store a phase advance angle map in which a phase advance angle map value and a load factor of a motor are associated in advance;
a calculation unit configured to calculate a load factor of the motor at a motor application voltage that is a voltage to be applied to the motor;
a setting unit configured to set a phase advance angle calculated on the basis of a phase advance angle map value and the motor application voltage, the phase advance angle map value being obtained from the phase advance angle map using the calculated load factor; and
a drive control unit configured to control the motor at the set phase advance angle.

### Supplementary Note 2

The motor control device according to Supplementary Note 1, in which the phase advance angle map is set such that a d-axis current of the motor is zero.

### Supplementary Note 3

The motor control device according to Supplementary Note 2, in which the phase advance angle map is set such that a phase advance angle is larger within a specific load factor range than a phase advance angle of the phase advance angle map set such that the d-axis current of the motor is zero.

### Supplementary Note 4

The motor control device according to any one of Supplementary Notes 1 to 3, in which the phase advance angle map is set such that the phase advance angle is a phase retard angle within a range in which the load factor is less than a predetermined value.

### Supplementary Note 5

The motor control device according to Supplementary Note 4, in which the range in which the load factor is less than the predetermined value is a range in which the load factor is negative.

### Supplementary Note 6

The motor control device according to any one of Supplementary Notes 1 to 5, in which the setting unit switches on a mode in which the phase advance angle is fixed in a case where rotation speed of the motor is less than or equal to a threshold.

### Supplementary Note 7

The motor control device according to any one of Supplementary Notes 1 to 6, further including a correction unit configured to correct the phase advance angle depending on temperature of the motor.

### Supplementary Note 8

The motor control device according to any one of Supplementary Notes 1 to 7, further including a correction unit configured to correct the phase advance angle on the basis of information obtained from outside.

### Supplementary Note 9

A motor control device including:
a storage unit configured to store a phase advance angle map in which a phase advance angle map value and rotation speed of a motor are associated in advance;
an estimation unit configured to estimate a load of the motor;
a calculation unit configured to calculate a phase advance angle correction value from the estimated load;
a setting unit configured to set a phase advance angle calculated on the basis of a phase advance angle map value and the calculated phase advance angle correction value, the phase advance angle map value being obtained from the phase advance angle map using actual rotation speed of the motor; and
a drive control unit configured to control the motor at the set phase advance angle.

### Supplementary Note 10

A motor control device including:
a storage unit configured to store a phase advance angle map in which a phase advance angle map value and a load of a motor are associated in advance;
an estimation unit configured to estimate a load of the motor;
a calculation unit configured to calculate a phase advance angle correction value from actual rotation speed of the motor;
a setting unit configured to set a phase advance angle calculated on the basis of a phase advance angle map value and the calculated phase advance angle correction value, the phase advance angle map value being obtained from the phase advance angle map using the estimated load; and
a drive control unit configured to control the motor at the set phase advance angle.

### Supplementary Note 11

A motor control device including:
a first storage unit configured to store a first phase advance angle map in which a phase advance angle map value and rotation speed of a motor are associated in advance;
a second storage unit configured to store a second phase advance angle map in which a phase advance angle map value and a load of the motor are associated in advance;
an estimation unit configured to estimate the load of the motor;
a setting unit configured to set a phase advance angle calculated using a first phase advance angle map value and a second phase advance angle map value, the first phase advance angle map value being obtained from the first phase advance angle map using actual rotation speed of the motor, the second phase advance angle map value obtained from the second phase advance angle map using the estimated load; and
a drive control unit configured to control the motor at the set phase advance angle.

### Supplementary Note 12

A motor control method by a motor control device including a storage unit configured to store a phase advance angle map in which a phase advance angle map value and a load factor of a motor are associated in advance, the motor control method including, by the motor control device:
calculating a load factor of the motor at a motor application voltage that is a voltage to be applied to the motor;
setting a phase advance angle calculated on the basis of a phase advance angle map value and the motor application voltage, the phase advance angle map value being obtained from the phase advance angle map using the calculated load factor; and
controlling the motor at the set phase advance angle.

The present disclosure is described in compliance with the embodiments, but the present disclosure is not limited to the embodiments and the configurations. The present disclosure encompasses even various modification examples and modifications within the equivalent scope. In addition, various combinations and modes, and further other combinations and modes including only one, more, or fewer of the elements also fall within the scope and the spirit of the present disclosure.

What is claimed is:

1. A motor control device comprising:
a storage unit configured to store a phase advance angle map in which a phase advance angle map value and a load factor of a motor are associated in advance;
a calculation unit configured to calculate a load factor of the motor by dividing a motor load voltage by a motor application voltage that is a voltage to be applied to the motor, the motor load voltage being calculated by subtracting a back electromotive voltage of the motor from the motor application voltage;
a setting unit configured to set a phase advance angle calculated on a basis of a phase advance angle map value and the motor application voltage, the phase advance angle map value being obtained from the phase advance angle map using the calculated load factor; and
a drive control unit configured to control the motor by outputting three-phase voltage at the set phase advance angle.

2. The motor control device according to claim 1, wherein
the phase advance angle map is set such that a d-axis current of the motor is zero.

3. The motor control device according to claim 2, wherein
the phase advance angle map is set such that a phase advance angle is larger within a specific load factor range than a phase advance angle of the phase advance angle map set such that the d-axis current of the motor is zero.

4. The motor control device according to claim 1, wherein
the phase advance angle map is set such that the phase advance angle is a phase retard angle within a range in which the load factor is less than a predetermined value.

5. The motor control device according to claim 4, wherein
the range in which the load factor is less than the predetermined value is a range in which the load factor is negative.

6. The motor control device according to claim 1, wherein
the setting unit switches on a mode in which the phase advance angle is fixed in a case where rotation speed of the motor is less than or equal to a threshold.

7. The motor control device according to claim 1, further comprising
a correction unit configured to correct the phase advance angle depending on temperature of the motor.

8. The motor control device according to claim 1, further comprising
a correction unit configured to correct the phase advance angle on a basis of information obtained from outside.

9. A motor control device comprising:
a storage unit configured to store a phase advance angle map in which a phase advance angle map value and rotation speed of a motor are associated in advance;
a calculation unit configured to calculate a motor load voltage by subtracting a back electromotive voltage of the motor from a motor application voltage that is a voltage to be applied to the motor;
a setting unit configured to set a phase advance angle calculated on a basis of a phase advance angle correction value calculated by the motor load voltage, a phase advance angle map value obtained from the phase advance angle map using actual rotation speed of the motor, and the motor application voltage;
a drive control unit configured to control the motor by outputting three-phase voltage at the set phase advance angle.

10. A motor control method performed by a motor control device including a storage unit configured to store a phase advance angle map in which a phase advance angle map value and a load factor of a motor are associated in advance, the motor control method comprising, by the motor control device:
calculating a load factor of the motor by dividing a motor load voltage by a motor application voltage that is a voltage to be applied to the motor, the motor load voltage being calculated by subtracting a back electromotive voltage of the motor from the motor application voltage;
setting a phase advance angle calculated on a basis of a phase advance angle map value and the motor application voltage, the phase advance angle map value being obtained from the phase advance angle map using the calculated load factor; and
controlling the motor by outputting three-phase voltage at the set phase advance angle.
